(19) United States
(12) Patent Application Publication
(10) Pub. No.: US 2007/0057936 A1
(43) Pub. Date: Mar. 15, 2007

(54) Display apparatus and method of providing power to light source

(75) Inventors: Sang-hoon Lee, Nam-gu (KR); Jeong-il Kang, Yongin-si (KR); Yung-jun Park, Yongin-si (KR); Kyoung-geun Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/496,444

(22) Filed: Aug. 1, 2006

(30) Foreign Application Priority Data
Sep. 12, 2005 (KR) 2005-84777

(51) Int. Cl. G09G 5/00

(52) U.S. Cl. 345/211

(57) ABSTRACT

The present invention provides a display apparatus and method supplying power to a light source where driving power is supplied to the light source, a main power path is provided through which the driving power is supplied from the power supply to the light source, a standby power path is branched from the main power path and returned to the power supply, a switching unit selects the driving power to be supplied from the power supply to either of the main power path or the standby power path, a standby power adjuster adjusts standby power applied to the standby power path and a controller controls the standby power adjuster to make the standby power be within an allowable range when the power is not applied to the main power path. Accordingly, a display apparatus and method which prevent a standby power from being continuously boosted up when a light source is turned off, thereby improving a display performance thereof are provided.

### CROSS-REFERENCE TO RELATED APPLICATIONS

This application claims the benefit under 35 U.S.C. §119(a) of Korean Patent Application No. 2005-0084777, filed on Sep. 12, 2005, in the Korean Intellectual Property Office, the entire disclosure of which is hereby incorporated by reference.

### BACKGROUND OF THE INVENTION

1. Field of the Invention

The present invention relates to a display apparatus and method. More particularly, the present invention relates to a display apparatus and method which can precisely control the intensity of a current applied to a predetermined light emitting device.

2. Description of the Related Art

A display apparatus has recently shown a tendency to employ a light emitting diode (LED) instead of a cold cathode fluorescent lamp (CCFL) as a light source. One reason a display apparatus employs the LED as the light source is that the color representation is improved.

The conventional display apparatus with the LED uses either of a linear method or a switching method in controlling the LED.

In the case of the linear method, the display apparatus includes a constant voltage source to generate a voltage to be applied to the LED, a switching unit to apply a current based on the voltage of the constant voltage source to the LED, and a pulse width modulation (PWM) generator to switch on/off the switching unit. The linear method has advantages of low noise and low ripple. However, because a certain current within a linear region should always be applied to the LED, a voltage loss arising in the switching unit increases by continuously applying the certain current within the linear region to the LED when the load of the LED is relatively large.

In the switching method, the display apparatus includes a constant current source to generate a current to be applied to the LED, a switching unit to apply the current from the constant current source to the LED, and a pulse width modulation (PWM) generator to switch on/off the switching unit. The conventional switching method applies a certain current to the LED in a PWM-on section for turning on the LED, and applies a ‘0’ current to the LED in a PWM-off section for turning off the LED. In the PWM-on section, the switching unit is switched on/off according to the intensity of the current flowing in the LED, so that the intensity of the current flowing in the LED minutely ripples. Therefore, a certain average current flows in the LED.

In the conventional switching method, the voltage loss is advantageously low. However, it is difficult to adjust the intensity of the current in the switching-on/off sections according to the characteristics of the switching device. The difficulty in adjusting the current when the switching device is switched on/off deteriorates the display performance of the display apparatus.

Accordingly, there is a need for an improved display device and method for precisely controlling the intensity of a current applied to a light emitting device.

### SUMMARY OF THE INVENTION

Exemplary embodiments of the present invention address at least the above problems and/or disadvantages and provide at least the advantages described below. Accordingly, it is an exemplary aspect of the present invention to provide a display apparatus and method which prevent a standby power from being continuously boosted up when a light source is turned off, thereby improving a display performance thereof.

Additional exemplary aspects and/or advantages of the present invention will be set forth in part in the description which follows and, in part, will be apparent from the description, or may be learned by practice of the present invention.

The foregoing and/or other exemplary aspects of the present invention can be achieved by providing a display apparatus with a light source and a method where, driving power is supplied to the light source, a main power path is provided through which the driving power is supplied from the power supply to the light source, a standby power path is branched from the main power path and returned to the power supply, a switching unit selects the driving power to be supplied from the power supply to either of the main power path or the standby power path, a standby power adjuster adjusts standby power applied to the standby power path, and a controller controls the standby power adjuster to make the standby power be within an allowable range when the power is not applied to the main power path.

According to another exemplary aspect of the present invention, a standby power adjuster comprises a pulse delayer to delay a minimum on-time pulse output from the power supply when the power is not applied to the main power path and an interrupter to cut off the minimum on-time pulse and the delayed minimum on-time pulse to be supplied to the standby power path by a predetermined operation.

According to another exemplary aspect of the present invention, the pulse delayer comprises at least one of a plurality of resistors and capacitors.

According to another exemplary aspect of the present invention, the standby power adjuster decreases the frequency of the minimum on-time pulse output from the power supply when the light source is turned off.

According to another exemplary aspect of the present invention, the standby power adjuster comprises a plurality of resistors connected in parallel and a switching device connected to at least one of the plurality of resistors.

According to another exemplary aspect of the present invention, the standby power adjuster disables the power supply when the standby power is higher than a predetermined command value.

According to another exemplary aspect of the present invention, the controller controls the switching unit to supply the driving power from the power supply to the main power path when the light source is turned on, and controls the switching unit to supply the driving power to the standby power path when the light source is turned off.

According to another exemplary aspect of the present invention, the controller outputs a PWM control signal to the switching unit, the PWM signal for turning off the switching unit to supply the driving power from the power supply to the main power path when the light source is turned on, and turning on the switching unit to supply the driving power to the standby power path when the light source is turned off.

According to another exemplary aspect of the present invention, the light source comprises an LED.

### BRIEF DESCRIPTION OF THE DRAWINGS

The above and/or other objects, features and advantages of certain embodiments of the present invention will be more apparent and more readily appreciated from the following description taken in conjunction with the accompany drawings in which:

FIG. 1 is a schematic circuit diagram of a display apparatus according to a first exemplary embodiment of the present invention;

FIG. 2 is an exemplary view of a pulse waveform according to the first exemplary embodiment of the present invention;

FIG. 3 is a control block diagram of a display apparatus according to a second exemplary embodiment of the present invention;

FIG. 4 is an exemplary view of a pulse waveform according to the second exemplary embodiment of the present invention; and

FIG. 5 is a control block diagram of a display apparatus according to a third exemplary embodiment of the present invention.

### DETAILED DESCRIPTION OF EXEMPLARY EMBODIMENTS

Reference will now be made in detail to the exemplary embodiments of the present invention which are illustrated in the accompanying drawings, wherein the same drawing reference numerals will be understood to refer to the same elements, features and structures throughout.

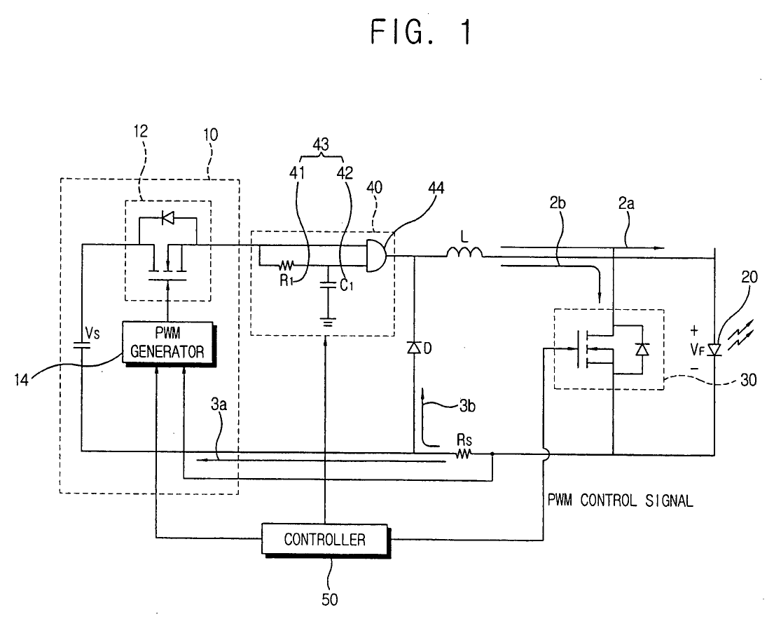

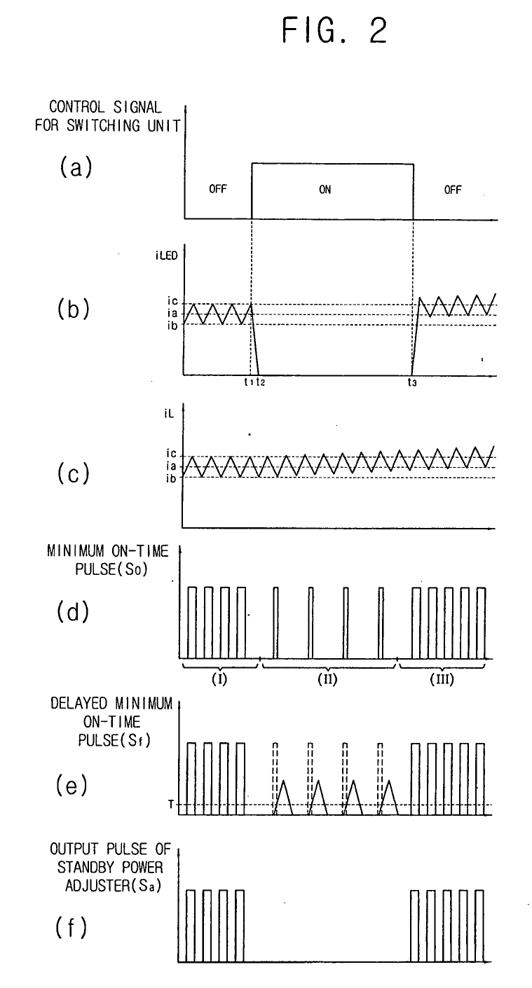

A display apparatus according to a first exemplary embodiment of the present invention will be described with reference to FIGS. 1 and 2.

FIG. 1 is a schematic circuit diagram of a display apparatus according to a first exemplary embodiment of the present invention, and FIG. 2 is an exemplary view of a pulse waveform according to the first exemplary embodiment of the present invention.

As shown in FIG. 1, a display apparatus according to an exemplary embodiment includes an LED unit 20 as a light source a power supply 10 to output a driving power, a main power path 2a through which the driving power is supplied from the power supply 10 to the LED unit 20, a standby power path 2b by which the driving power supplied to the LED unit 20 is intercepted, a switching unit 30 to select the driving power to be supplied from the power supply 10 to either of the main power path 2a or the standby power path 2b, a standby power adjuster 40 to adjust a standby power flowing in the standby power path 2b, and a controller 50 to control the switching unit 30 to make the driving power be supplied from the power supply 10 to the main power path 2a when the LED unit 20 is turned on and to the standby power path 2b when the LED unit 20 is turned off.

The LED unit 20 emits light to a display unit (not shown) for displaying an image. In an exemplary embodiment, the light source employs a light emitting diode, but it is not limited thereto. The LED unit 20 may include a plurality of LED devices.

The power supply 10 supplies the driving power to the LED unit 20. Preferably, the power supply 10 according to an exemplary embodiment employs a current source to generate a current. The power supply 10 includes a power source V_{S} to generate power V_{F} determined by the LED unit 20, a PWM generator 14 to control a current flow so as to maintain the brightness of the LED unit 20 in accordance with a command value, and a current maintenance switching unit 12 to control the current flowing from the power source V_{S} to the LED unit 20.

Between the power supply 10 and the switching unit 30 are provided an inductor L, a current sensing resistor R_{S} and a diode D. The inductor L is provided between the current maintenance switching unit 12 and a node at which the main power path 2a and the standby power path 2b are branched off. The current sensing resistor R_{S} is provided between the power source V_{S} and a node at which the main power path 2a and the standby power path 2b are joined together. The diode D has an anode connected between the current sensing resistor R_{S} and the power source V_{S}, and a cathode connected between the current maintenance switching unit 12 and the inductor L. In this exemplary embodiment, the inductor L, the current sensing resistor R_{S} and the diode D are not included in the power supply 10 so as to place the standby power adjustor 40 in an output terminal of the current maintenance switching unit 12. However, the power supply 10 for supplying the power to the light source (i.e., LED unit 20) generally includes the inductor L, the current sensing resistor R_{S} and the diode D. That is, the configuration of the power supply 10 is not limited to the present exemplary embodiment.

The current maintenance switching unit 12 controls the current flow from the power source V_{S} to the LED unit 20. In this exemplary embodiment, the current maintenance switching unit 12 is implemented by a metal oxide semiconductor field effect transistor (MOSTET) that is turned on/off by a PWM control of the PWM generator 14.

The PWM generator 14 PWM-controls the current maintenance switching unit 12, and causes the power supply 10 to output constant driving power for maintaining the brightness of the LED unit 20 in accordance with a command value. The PWM generator 14 receives a lighting control signal (i.e., a command value) for the LED unit 20 from the controller 50 in an initial driving stage, and turns on the current maintenance switching unit 12 on the basis of the lighting control signal. Then, the PWM generator 14 detects a comparative voltage applied to the current sensing resistor R_{S}, and compares the detected comparative voltage with the command value, thereby determining whether the intensity of a current flowing in either of the main power path 2a or the standby power path 2b is higher than a value. When the detected comparative voltage is higher than the command value, the PWM generator 14 turns off the current maintenance switching unit 12. When a time period elapses after turning off the current maintenance switching unit 12, the PWM generator 14 turns on the current maintenance switching unit 12. That is, the PWM generator 12 turns on the current maintenance switching unit 12 according to the control of the controller 50 in the initial driving stage of the display apparatus, and alternately turns on and off the current maintenance switching unit 12 on the basis of a result from comparing the comparative voltage applied to the current sensing resistor R_{S} with the command value and a time period. Thus, while the display apparatus is turned on, the power supply 10 maintains the constant driving power regardless of whether the LED unit 20 is turned on or off.

On the other hand, when the display apparatus is turned off, the PWM generator 14 is disabled by the controller 50, so that the power supply 10 preferably does not output the driving power.

The switching unit 30 switches the driving power supplied from the power supply 10 to either of the main power path 2a or the standby power path 2b. In an exemplary embodiment, the switching unit 30 is implemented by a MOSFET provided in the standby power path 2b, turned on/off by the PWM control signal, and intercepting the driving power supplied from the power supply 10 to the LED unit 20.

Referring to (a) through (d) of FIG. 2, a control method of supplying the driving power when the LED unit 20 is turned on and off will be described. In FIG. 2, (a) shows a switching control signal transmitted from the controller 50 to the switching unit 30; (b) shows that the LED unit 20 is turned on/off by the switching control signal; and (c) shows a current applied to an inductor (L).

First, when a power key (not shown) is input to start operating the display apparatus, the controller 50 controls the power supply 10 to output a driving current corresponding to a command value. Here, the output of the driving current is originated from the PWM generator 14 that receives the lighting control signal (i.e., the command value) from the controller 50 and thus turns on the current maintenance switching unit 12. For example, the LED unit 20 is turned on/off as follows. In the case where blue (B) is not needed in currently displaying an image, the LED units for red (R) and green (G) among the LED units corresponding to R, G and B are turned on and receive the driving current, but the LED unit for blue (B) is turned off and does not receive the driving power. In this case, the LED unit 20 is turned off for a moment. The waveforms of FIG. 2 show that one of the LED units 20 is turned on after driving the display apparatus, and turned off for a moment and turned on again.

The controller 50 outputs the PWM control signal to turn the switching unit 30 off while a current I_{LED} flows in the LED unit 20 (˜t1, t3˜). Thus, the driving current output from the power source VS is charged in the inductor L through the current maintenance switching unit 12, flows in a path 3a to the LED unit 20 provided in the main power path 2a and to the power supply 10 via the current sensing resistor R_{S} (i.e., the driving current: V_{S}→L →LED unit 20 →R_{S}→V_{S}).

Then, the PWM generator 14 detects the comparative voltage applied to the current sensing resistor R_{S}, and compares the detected comparative voltage with the command value. When the detected comparative voltage is higher than the command value, the PWM generator 14 determines that the intensity of the driving current flowing in the LED unit 20 is higher than a current value I_{c}, thereby turning off the current maintenance switching unit 12. Thus, the current charged in the inductor L flows in a path 3b to the LED unit 20 via the main power path 2a and to the diode D via the current sensing resistor R_{S} (i.e., the driving current path: L →LED unit 20 →R_{S}→D →L).

Thus, the PWM generator 14 alternately turns on and off the current maintenance switching unit 12 on the basis of a result from comparing the comparative voltage applied to the current sensing resistor R_{S} with the command value and a time period. Therefore, the current flowing in the inductor L and the LED unit 20 is maintained to have an intensity of Iₐ as an average of a current I_{c} and a current I_{b}.

When the LED unit 20 is turned off at a time of t1, the controller 50 outputs the PWM control signal to turn on the switching unit 30 as shown in (a) of FIG. 2. At the time of t1, the intensity of the current flowing in the LED unit 20 reaches the current I_{c}, so that the PWM generator 14 turns off the current maintenance switching unit 12. Therefore, from the time of t1, the current charged in the inductor L flows through the switching unit 30 provided in the standby power path 2b in the path 3b to the diode D via the current sensing resistor R_{S} (i.e., the driving current: L →switching unit 30 →R_{S}→D →L). Thus, the current flowing in the inductor L (refer to (b) of FIG. 2) is decreased from the time of t1. Also, the current flowing in the LED unit 20 (refer to (b) of FIG. 2) is promptly intercepted and vanishes (i.e., “0”) at a time of t2. Thus, a response time for turning off the LED unit 20 is shortened.

Then, the PWM generator 14 turns on the current maintenance switching unit 12 again when a time period elapses after turning off the current maintenance switching unit 12. Therefore, the driving current output from the power source V_{S} is charged in the inductor L through the current maintenance switching unit 12, and flows in the path 3a to the power supply 10 via the switching unit 30 of the standby power path 2b and the current sensing resistor R_{S} (i.e., the driving current: V_{S}→L →switching unit 30 →R_{S}→V_{S}).

Thus, even when the LED unit 20 is turned off, the PWM generator 14 alternately turns on/off the current maintenance switching unit 12 on the basis of the result from comparing the comparative voltage applied to the current sensing resistor R_{S} with the command value and a time period.

As shown in (d) of FIG. 2, the generally commercialized PWM generator 14 inherently outputs a minimum on-time pulse S₀ before generating a pulse for power generation. Therefore, a remained current flows every time when the minimum on-time pulse S₀ is generated. The longer an off-stage II in which the LED unit 20 is turned off is, the more the remained current due to the minimum on-time pulse is accumulated. Therefore, more and more current is stored in the inductor L (refer to (c) of FIG. 2). Such excessive current causes the inductor L to supply not a desired current but an excessive current to the LED unit 20 in an on-stage III in which the LED unit 20 is turned on. That is, the current applied to the LED unit 20 increases more and more after a time of t3,in other words, while the LED unit 20 is turned on again (III) (refer to (b) of FIG. 2). This phenomenon is repeated successively while the display apparatus is driven, so that the LED unit 20 cannot properly receive the power.

The standby power adjustor 40 adjusts the power flowing in the standby power path 2b by the control of the controller 50 when the light source is turned off, in other words, when the power is not supplied to the main power path 2a. As described above, while the display apparatus is operating, the constant driving power is maintained by the PWM generator 14 regardless of whether the LED unit 20 is turned on or off. That is, even when the LED unit 20 is turned off, the power prepared for turning on the LED unit 20 is applied to the standby power path 2b, and the remained current causes the current charged in the inductor L to increase.

Therefore, a display apparatus according to an exemplary embodiment of the present invention includes the standby power adjuster 40 provided in the output terminal of the current maintenance switching unit 12 for the power generation. The standby power adjuster 40 is provided for removing or minimizing the minimum on-time pulse S₀ generating the remained current. Further, the standby power adjuster 40 includes a pulse delayer 43 to output a delay remained current by delaying the minimum on-time pulse S₀, and an interrupter 44 to not allow any current to flow toward the standby power path 2b.

The pulse delayer 43 includes a resistor R1:41 and a capacitor C1:42, wherein such a resistive element delays the minimum on-time pulse S₀ output from the power supply 10. In FIG. 2, (e) shows the delayed minimum on-time pulse S₁. The minimum on-time pulse S₀ generated when the LED unit 20 is turned off is delayed by a predetermined time. A delay time of the minimum on-time pulse S₀ can be obtained by 1/R1*C1. Therefore, the delay time decreases as the resistance of the resistor R1 or the capacitance of the capacitor C1 increases. On the other hand, the delay time increases as the resistance of the resistor R1 or the capacitance of the capacitor C1 decreases. Thus, the minimum on-time pulse S₀ is delayed by adjusting the resistance of the resistor R1 or the capacitance of the capacitor C1, thereby resulting in reducing the remained current generated by the minimum on-time pulse S₀. Here, the resistor 41 and the capacitor 42 may be plurally provided respectively, but are not limited to the numbers thereof

The interrupter 44 receives the original minimum on-time pulse S₀ and the delayed minimum on-time pulse S₁, and applies a predetermined logic operation thereto. As shown in (e) of FIG. 2, the original minimum on-time pulse S₀ and the delayed minimum on-time pulse S₁ are overlapped in a predetermined section. At this time, the overlapped section is set as a limitation value (T). Then, a value higher than the limitation value (T) is set as “1”, and a value lower than the limitation value (T) is set as “0”. Here, if two received values are calculated by an AND gate, the output is always “0” and thus any signal is not output to the standby power path 2b. Therefore, the interrupter 44 according to an exemplary embodiment of the present invention is implemented by an operating device to apply a logic operation to the input values. Particularly, the interrupter 44 may be implemented by an AND gate operating device. Here, the delay time to delay the minimum on-time pulse and the limitation value (T) are set according to the properties of the PWM generator 14, and the control signal thereof can be output from the controller 50. Alternatively, the standby power adjuster 40 may have information about the delay time and the limitation value in itself.

As shown in (f) of FIG. 2, the standby power adjuster 40 does not generate any pulse signal while the LED unit 20 is turned off.

The standby power adjuster 40 is not limited to the pulse delayer 43 and general logic such as the AND gate operating device. Alternatively, a programmable logic device may be used as the standby power adjuster 40.

When the power key (not shown) for the display apparatus is operated, the controller 50 controls internal circuits (not shown) of the display apparatus to be enabled, and at the same time outputs the lighting control signal (that is, a command value) for the LED unit 20 to the PWM generator 14.

Further, the controller 50 outputs the PWM control signal to control the switching unit 30, thereby either supplying the driving power to the main power path 2a when the LED unit 20 is turned on or to the standby power path 2b when the LED unit 20 is turned off. That is, the controller 50 turns off the switching unit 30 to supply the driving power from the power supply 10 to the LED unit 20 when the LED unit 20 is turned on, and turns on the switching unit 30 to supply the driving power for the LED unit 20 to the standby power path 2b when the LED unit 20 is turned off.

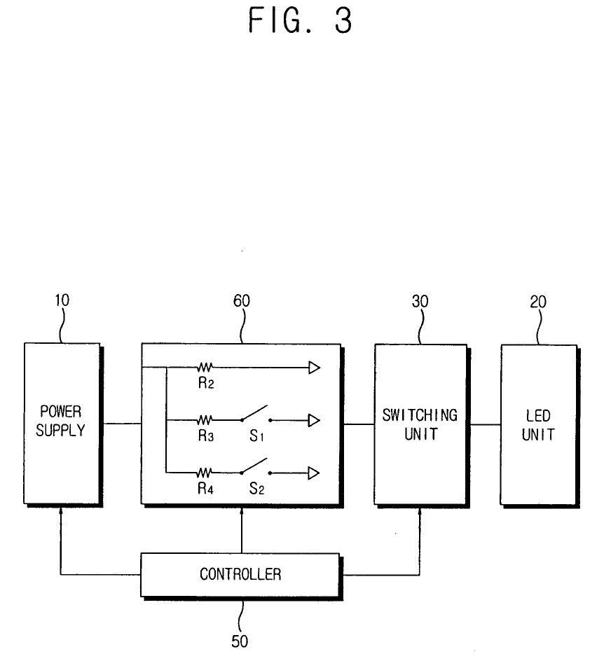

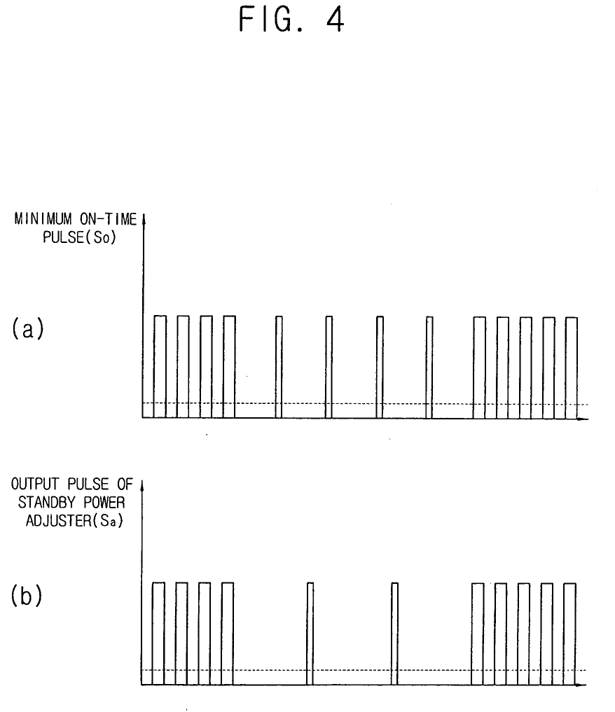

Also, the controller 50 controls the standby power adjuster 40 according to whether the LED unit 20 is turned on or off, thereby making the standby current applied to the inductor L be within an allowable range, in other words, between the current values I_{c} and I_{b}. Below, a display apparatus according to a second exemplary embodiment of the present invention will be described with reference to FIGS. 3 and 4. FIG. 3 is a control block diagram of a display apparatus according to a second exemplary embodiment of the present invention. FIG. 4 is an exemplary view of a pulse waveform according to the second exemplary embodiment of the present invention. As shown therein, the display apparatus according to the second exemplary embodiment includes the same configurations as that of the first exemplary embodiment except a standby power adjuster 60. Therefore, repetitive descriptions will be avoided as necessary.

In this exemplary embodiment, the standby power adjuster 60 decreases the frequency of the minimum on-time pulse S₀ output from the power supply 10 when the LED unit 20 is turned off, in other words, when the power is not supplied to the main power path 2b. For this, the standby power adjuster 60 includes a plurality of resistors R2, R3 and R4 connected in parallel, and switching devices S₁ and S₂ connected to at least one of the plurality of resistors R2, R3 and R4.

This is similar to the principle of the pulse delayer 43 according to the first exemplary embodiment. That is, the current maintenance switching unit 12 is connected with a resistive element in parallel to thereby change the minimum on-time pulse S₀ output from the current maintenance switching unit 12.

The more switching devices S1, S2 are turned on, the more resistors are connected in parallel. Therefore, total resistance decreases. The lower the resistance is, the longer the period of the pulse is in inverse relation to the resistance. Thus, the frequency of the minimum on-time pulse S₀ decreases. In FIG. 4, (a) shows the minimum on-time pulse S₀ when the standby power adjuster 60 is not provided like (d) of FIG. 2; and (b) shows the minimum on-time pulse S₃ decreased in frequency by the switching devices S₁ and S₂, in other words, the pulse outputted from the standby power adjuster 60. This shows that the minimum on-time pulse S₀ is decreased in half by the PWM generator 14 while the LED unit 20 is turned off. Such waveforms are shown by way of example. If the frequency of the minimum on-time pulse S₀ is largely decreased by increasing the number of resistors connected in parallel, the minimum on-time pulse S₀ can be entirely cut off while the LED unit 20 is turned off.

Alternatively, the number of resistors R2, R3 and R4 and the number of switching devices S₁ and S₂ connected to the resistors R2, R3 and R4 may vary. Here, the number of switching devices S₁ and S2 to be turned on is controlled by the controller 50. The controller 50 senses the remained current generated by the minimum on-time pulse S₀ and the intensity of the current accumulated in the inductor L due to the remained current while the LED unit 20 is turned off, thereby turning on a proper number of switching devices S₁ and S₂.

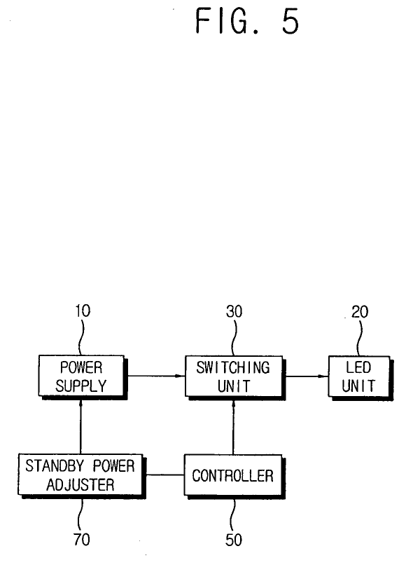

FIG. 5 is a control block diagram of a display apparatus according to a third exemplary embodiment of the present invention. As shown therein, a standby power adjuster 70 is provided between the power supply 10 and the controller 50, which is different from those provided between the power supply 10 and the switching unit 30 in the first and second exemplary embodiments.

In this exemplary embodiment, the standby power adjuster 70 generates a signal for disabling the PWM generator 14 in accordance with the control of the controller 50. For example, the controller 50 senses the intensity of the current flowing in the current sensing resistor R_{S}, and determines whether the sensed intensity is within an allowable range. In results, when the sensed intensity is within the allowable range, the controller 50 does not output any control signal to the standby power adjuster 70. In this case, the PWM generator 14 goes on operating without any change. On the other hand, when the sensed intensity is beyond the allowable range, the controller 50 controls the standby power adjuster 70 to generate the signal for disabling the PWM generator 14. Thus, the controller 50 continuously senses and determines the intensity of the current, thereby transmitting a control signal to the standby power adjuster 70.

Here, the standby power adjuster 70 may be implemented by a device such as a surge state buffer. When the intensity of the current to be inputted to the PWM generator 14 reaches a predetermined surge state, the surge state buffer becomes active-high, thereby disabling the PWM generator 14 in itself.

Alternatively, the controller 50 can apply the disable signal to the PWM generator 14 by itself without the standby power adjuster 70. Further, the controller 50 may employ a certain logic element programmed for the foregoing signal control.

As described above, the exemplary embodiments of the present invention provide a display apparatus which prevents a standby power from being continuously boosted up when a light source is turned off, thereby improving a display performance thereof.

Although exemplary embodiments of the present invention have been shown and described, it will be appreciated by those skilled in the art that changes may be made in these exemplary embodiments without departing from the principles and spirit of the invention, the scope of which is defined in the appended claims and the full scope of equivalents thereof.

What is claimed is:

1. A display apparatus, comprising:
a light source;
a power supply configured to supply power to the light source;
a main power path through which the power is supplied from the power supply to the light source;
a standby power path branched from the main power path and returning to the power supply;
a switching unit to switch to one of the main power path and the standby power path as a path for the power from the power supply;
a standby power adjuster to adjust standby power applied to the standby power path; and
a controller to control the standby power adjuster to make the standby power be within an allowable range when the power is not applied to the main power path.

2. The display apparatus according to claim 1, wherein the standby power adjuster comprises:
a pulse delayer to delay an on-time pulse output from the power supply when the power is not switched to the main power path; and
an interrupter to cut off the on-time pulse and the delayed on-time pulse to be supplied to the standby power path by a predetermined operation.

3. The display apparatus according to claim 2, wherein the pulse delayer comprises at least one of a resistor and a capacitor.

4. The display apparatus according to claim 1, wherein the standby power adjuster decreases a frequency of the on-time pulse output from the power supply when the light source is off.

5. The display apparatus according to claim 4, wherein the standby power adjuster comprises:
a plurality of resistors connected in parallel; and
a switching device connected to at least one of the plurality of resistors.

6. The display apparatus according to claim 1, wherein the standby power adjuster disables the power supply when the standby power is higher than a command value.

7. The display apparatus according to claim 1, further comprising a controller, wherein the controller controls the switching unit to supply the power from the power supply to the main power path when the light source is turned on, and controls the switching unit to supply the power to the standby power path when the light source is turned off.

8. The display apparatus according to claim 7, wherein the controller outputs a PWM control signal to the switching unit for turning off the switching unit to supply the power from the power supply to the main power path when the light source is turned on, and turning on the switching unit to supply the power to the standby power path when the light source is turned off.

9. The display apparatus according to claim 1, wherein the light source comprises an LED.

10. The display apparatus according to claim 2, wherein the on-time pulse is a minimum on-time pulse.

11. A method for providing power to a light source, the method comprising:
selectively supplying power from a power supply to a light source through a main power path;
selectively supplying power from a power supply to a standby power path branched from the main power path;
delaying an on-time pulse output from the power supply when the power is not supplied through the main power path; and
interrupting the on-time pulse and the delayed on-time pulse.
